(19) United States
(12) Patent Application Publication
(10) Pub. No.: US 2025/0001343 A1
(43) Pub. Date: Jan. 2, 2025

(54) INTERIOR ROOM AIR FILTER MODULE AND FILTER ASSEMBLY

(71) Applicant: MANN+HUMMEL GmbH, Ludwigsburg (DE)

(72) Inventors: Christian HAYNL, Bayreuth (DE); Peter PEKNY, Neuenmarkt (DE); Andreas KLOSS, Mannheim (DE)

(21) Appl. No.: 18/830,664

(22) Filed: Sep. 11, 2024

Related U.S. Application Data
(63) Continuation of application No. PCT/EP2023/053891, filed on Feb. 16, 2023.

(30) Foreign Application Priority Data
Mar. 11, 2022 (DE) 102022105786.0

(51) Int. Cl. B01D 46/00; B01D 46/52

(52) U.S. Cl. CPC B01D 46/0036; B01D 46/0013; B01D 46/521; B01D 2265/04; B01D 2271/022; B01D 2275/10

(57) ABSTRACT

An interior room air filter module has a particle filter element, an adsorption filter element, and a frame with a radially protruding seal flange surrounding them. The particle filter element has a folded pack with zigzag-folded layers of filter medium. The layers include a layer with an aerosol-separating filter medium, an inflow-side first layer, and an outflow-side second layer at the particle filter element. The first and second layers, for forming the folded pack, are folded while resting on each other. The adsorption filter element has shaped bodies in the form of honeycomb bodies which adsorb at least hydrocarbons. The seal flange laterally surrounds the adsorption filter element at a circumferential exterior wall thereof. A filter assembly has a filter housing for receiving such an air filter module and has first and second seal sections following a contour of the seal flange or seal attached thereto.

### CROSS-REFERENCE TO RELATED APPLICATIONS

This application is a continuation application of international application No. PCT/EP2023/053891 having an international filing date of Feb. 16, 2023, and designating the United States, the international application claiming a priority date of Mar. 11, 2022, based on prior filed German patent application No. 10 2022 105 786.0, the entire contents of the aforesaid international application and the aforesaid German patent application being incorporated herein by reference.

### BACKGROUND

The present invention concerns a filter element, in particular an interior room air filter module for filtering air supplied to a driver cabin in vehicles, agricultural machines, construction machines, and work machines. Furthermore, the invention concerns a filter assembly for and with such a filter element.

Filter module and filter insert are generally understood as inserts which can be arranged exchangeably as a unit in a filter housing and which comprise at least one filter element of a filter medium and usually also a structure carrying or supporting the filter medium and most of the time a seal. The respective filter medium exhibits generally a limited service life. Because of this, filter modules must be regularly exchanged as a unit.

The air which is flowing into a vehicle cabin is nowadays freed as completely as possible from contaminants. Possibly occurring contaminants are, for example, particulate matter, pollen, soot, harmful gases or aerosols. In particular in applications in which high concentrations of plant protectants or liquid fertilizers occur in the ambient air upon use of spraying devices for these substances, the filtration of such contaminants is important. For this purpose, various filter media are available. Generally, particle filters, active carbon filters, and HEPA filters are used, for example. They are combined in various layers and various arrangements in order to obtain the desired filtration effect for the interior room air.

EP 3 520 878 A1 discloses a filter module for filtering interior room air with three filter layers, wherein the filter layers are arranged in a common frame which is assembled from extruded profile strips. One of the filter layers comprises an adsorption filter configured as a honeycomb body while the other two filter layers comprise particle filters. The particle filter layers comprise separate filter bellows that can be flowed through in series, wherein one of the filter bellows comprises a HEPA filter medium. The profile strips of the frame hold inwardly the plurality of filter layers; outwardly, the filter module is fastened by the frame seal-tightly in a housing.

The filter module of EP 3 520 878 A1 comprises a circumferentially extending seal flange formed at the profile strips which projects radially outwardly in the region of the two particle filter elements. Since the honeycomb body is typically a rather massive device component, the positioning of the seal flange disclosed therein is technically disadvantageous in view of the background of the action of a vibration load. The profile strips comprise furthermore two circumferentially extending collar sections which protrude inwardly and at which two of the filter layers are supported, respectively. This construction in combination with the embodiment of the particle filter layers as separate filter bellows requires a comparatively large installation space in axial direction.

The increasingly more intensive integration of various components in the machine region and the desire for longer filter service lives lead to conflicting goals in regard to the arrangement and the construction of interior room air filters. For a high integration, a very compact construction and a filter volume as small as possible are advantageous. Longer service lives, on the other hand, require in general larger filter volumes. Furthermore, a safe fixation of the filter modules and their stability even in case of vibrations and shocks in operation of the vehicle must be guaranteed. Particularly the stability against vibrations is frequently not ensured in case of filter modules of the prior art.

It is therefore desirable to provide an installation space-reduced filter module which operates reliably even under vibration effects in vehicle operation.

### SUMMARY

In view of this background, the present invention is based on the object of providing an improved filter element or filter module.

Accordingly, a filter module, in particular an interior room air filter module, is proposed, which comprises:
a particle filter element,
an adsorption filter element, and
a frame circumferentially surrounding the particle filter element and the adsorption filter element and comprising a radially protruding seal flange.

In this context, the particle filter element may comprise a folded pack which is formed of a plurality of layers of a filter medium folded in a zigzag shape.

For example, at least one layer comprises an aerosol-separating filter medium.

The adsorption filter element may comprise at least an at least hydrocarbon-adsorbing shaped body. In addition, the shaped body can also be embodied to adsorb other harmful gases, for example, NH3 and/or H2S.

The seal flange may be arranged such that it laterally encloses or surrounds the adsorption filter element at a circumferentially extending exterior wall thereof. A seal can be arranged at the seal flange. The seal can be for example injection-molded to the seal flange or can be mounted on the seal flange as a separate part. As an alternative or in addition, the seal can comprise a first section arranged at a first axial surface of the seal flange and comprise a second section arranged at a second axial surface of the seal flange, wherein the second axial surface of the seal flange faces away from the first axial surface of the seal flange. In this way, in the installed state of the filter module, an inner sealing action of the raw air region in relation to the clean air region as well as an external sealing action in relation to the environment can be realized. In other words, the seal can be a bidirectional axial seal.

Such an arrangement of the seal flange is advantageous in operation of the filter module according to the invention because the seal flange, in relation to the axial direction, is located in this way as close as possible at the center of mass of the filter module. This improves the reliability of the filter module because there is in particular a smaller risk that the frame becomes damaged by forces caused by a vibration load.

In particular, the particle filter element and the adsorption filter element may be arranged in the filter module according to the invention such that they can be flowed through in series. In particular, the particle filter element and the adsorption filter element may be arranged such that the particle filter element is arranged upstream of the adsorption filter element so that an air flow passing through the filter module according to the invention first flows through the particle filter element and subsequently the adsorption filter element. This has the advantage that the adsorption filter element can be flowed through by air from which particles have been removed which improves the adsorption performance of the adsorption filter element, for example considered over time, because the pores or channels of the adsorption filter element do not become clogged by particles.

The proposed filter module permits a compact construction which enables the use in installation space-limited applications and, due to the frame configuration with the seal flange provided for example in the region of the adsorption filter element, ensures a reliable installation and a reliable filter function even in case of vibrations in operation.

In this context, the interior room air filter module is suitable as an exchangeable component for an interior room air filter for a driver cabin of agricultural and work machines, for example with squirting or spraying devices for plant protectants or fertilizers, and can be installed in a filter housing fixed at the vehicle.

The respective layer of the filter medium used in the particle filter element can be embodied folded or corrugated. As folds, for example, zigzag folds or W folds are known. The filter medium can be embossed and subsequently folded sharp-edged at embossed edges with formation of fold edges. A flat material filter sheet can serve as a starting material which is then correspondingly shaped.

For example, the respective filter medium is a filter fabric, a laid filter or a filter nonwoven. In particular, the filter medium can be produced by a spunbonding or meltblowing method. Furthermore, the filter medium can be felted or needled. The filter medium can comprise natural fibers such as cotton or synthetic fibers, for example, of polyester, polyphenylene sulfide or polytetrafluoroethylene. During machining, the fibers can be oriented in, at a slant to and/or transversely to the machine direction.

Furthermore, it can comprise an adsorption agent such as active carbon in or between the layers. Furthermore, the filter medium can comprise an antimicrobial and/or antiallergic action. As an antimicrobial substance, for example, zinc pyrithione or nanosilver, as an antiallergic substance, for example, polyphenol, is conceivable.

A corresponding filter module serves for filtering fluids, thus gaseous and/or liquid media, for example, air. A gaseous medium or air encompasses here also gas or air/solid mixtures and/or gas or air/liquid mixtures. For example, an air conditioning device can comprise the filter element.

An open filter medium can be configured to remove particles of the test dust A4 according to ISO 12103-1 from an air flow at a filtration rate of 0.05 to 0.30 m/s, in relation to the filter media surface, at an air permeability of greater than 3,000 l/m2s (determined according to ISO 9237 at 200 Pa). The determination of the filtration characteristic values can be done, for example, according to DIN 14269-4.

A particularly high-separation filter medium can be configured to remove particles of the test dust A2 according to ISO 12103-1 as well as NaCl aerosol particles according to DIN 71460-1 from an air flow at a filtration rate of 0.05 to 0.30 m/s, in relation to the filter media surface, at an air permeability of greater than 170 l/m2s (determined according to ISO 9237 at 200 Pa). The determination of the filtration characteristic values can be done, for example, according to DIN 14269-4.

In embodiments, one of the plurality of layers of the particle filter element comprises an aerosol-separating particle filter medium of the filtration class H13 or H14 according to DIN EN 1822-1. In other words, at least one of the layers of the particle filter element can be a HEPA filter medium. Conceivable is the use of a nonwoven material of plastic material or glass fiber. In embodiments, an aerosol-filtering layer downstream is produced of a HEPA aerosol medium of ePTFE.

The particle filter element comprises at the inflow side a first layer and at the outflow side a second layer, wherein, for forming the folded pack, the layers are folded or co-pleated while resting on each other. Here, Aresting on each other@ is understood not only as a direct contact but also an indirect contact with intermediate positioning of further structures, e.g., adhesive layers or adhesive tracks.

The first layer can retain dust particles at the inflow side to the greatest possible extent while the second layer at the outflow side can be configured as an aerosol medium. The clogging of the aerosol layer with particles is thereby reduced.

As first layer which can be referred to as pre-filter layer, for example, a cellulose filter medium with epoxide impregnation is used. Preferably, the cellulose filter medium has a grammage of 80-140 g/m5, preferably 100-120 g/m5. In a preferred embodiment, the medium has a maximum pore size in the range of 30-40 om and/or an air permeability of approximately 100-400 l/m2s, preferably between 200 and 300 l/m2s, measured respectively at a pressure differential of 200 Pa (measured here and in the following preferably according to DIN EN ISO 9237). In this manner, the subsequent layers can be protected from dust deposit and their function can be ensured thereby. In a further embodiment, the impregnation contents, i.e., the weight proportion of the impregnation agent in the grammage of the filter medium, amounts to between 15 and 30%.

As nonwoven filter medium for the pre-filter layer, for example, a combination of a spunbond layer and a meltblown layer (nonwoven of meltblown synthetic fibers) can be used. Both layers can be produced respectively of polyamide (PA), polyester (PES) or polypropylene (PP). The nonwoven filter medium comprises preferably a grammage between 60 and 140 g/m5, preferably between 80 and 120 g/m5, and/or a thickness in the range of 0.5-1 mm, particularly preferred of 0.5-0.8 mm. Further preferred, the air permeability lies in the range of 1,000-2,000 l/m2s, particularly preferred between 1,200 and 1,800 l/m2s at a pressure differential of 200 Pa.

In an embodiment, the pre-filter layer comprises, according to ISO 5011, a degree of separation of 99% for test dust A2 or A4 according to ISO 12103-1.

The pre-filter layer comprises in one embodiment a grammage of 75-125 g/m5. For example, the filter medium of the pre-filter layer comprises an air permeability of 100-200 l/m2s at a pressure differential of 200 Pa.

The second layer which can be referred to as fine filter layer can be designed as a HEPA bellows layer. In an embodiment, a filter medium with glass fibers in a glass fiber layer, which is initially not folded, is used as a fine filter layer. In this context, for example, a glass fiber nonwoven or glass fiber paper can be used. It comprises, for example, a laminated cover layer of a spunbond nonwoven at one side or both sides. In this way, a mechanical protection of the usually very sensitive glass fiber medium may be achieved. This is advantageous when the glass fiber layer is folded because the medium can be protected in this way from damages from folding, which could lead to local leaks or to cracks. Furthermore, such cover layers can serve for improving the mechanical stability of the fine filter layer.

In an embodiment of the fine filter layer, the glass fibers comprise a fiber diameter in the range of 800 nm to 5 Φm. Preferably, 90% of the fibers comprise a fiber diameter within this range. Preferably, fibers with fiber diameters substantially in the entire fiber diameter range are present. Preferably, the average fiber diameter is within the aforementioned range. The fiber diameters can be measured, for example, according to the method described in DE 10 2009 043 273 A1 or US 2011/0235867 A1. Preferably, the filter medium of the fine filter layer comprises a grammage between 60 and 100 g/m5, particularly preferred between 75 and 90 g/m5. The glass fiber layer comprises preferably a thickness of 0.2-1 mm, particularly preferred of 0.3-0.6 mm. Particularly preferred, a glass fiber layer is used which generates, at an inflow rate of 7.5 cm/s, a resistance in the range of 300-600 Pa, preferably between 400 and 500 Pa. The air permeability (permeability) lies preferably in the range of 25 to 45 l/m2s at a pressure loss of 200 Pa. At a flow rate of 5.3 cm/s, the pressure loss preferably lies in the range of 200-700 Pa, particularly preferred between 450 and 600 Pa or alternatively between 270-480 Pa. The pore size can lie in the range between 5 and 12 m, for example between 8 and 10 Φm.

Instead of glass fibers, synthetic fibers can be used also for the fine filter layer. In an embodiment, such a synthetic HEPA medium is used in place of the described glass fiber media. In this context, polyester or polypropylene or polyamide can be used as a material, for example; the fiber layers may then be embodied in nonwoven form and, for example, produced by the electrospinning method, by the meltblowing method or in any other way. Preferably, an electret medium is employed in this context. Due to the material properties of the synthetic filter media, cover and protective layers can be advantageously dispensed with. Preferably, a layer of meltblown nonwoven of polyester is used with a grammage of, for example, 80-160 g/m5, preferably between 80 and 120 g/m5, and a thickness of, for example, approximately 0.4 to 1 mm. Further preferred, it is applied onto a carrier layer. As a carrier layer, for example, a plastic support grid or a spunbond nonwoven is conceivable. The further properties can correspond to those of the described fine filter layers with glass fibers.

The particle filter element may have an aerosol penetration of #0.05% measured according to EN 15695.

Compared to the prior art, this integrated construction of a pre-filter layer and of a fine filter layer within the particle filter element provides the advantage that the required installation space in axial direction can be significantly reduced while substantially maintaining the filtration performance. In comparison to an embodiment which uses separate filter bellows as pre-filter layer and fine filter layer, the axial installation space advantage amounts to up to 50%.

In embodiments, the particle filter element comprises a frame circumferentially surrounding the folded pack and comprising lateral strips applied to fold profiles of the folded filter medium and head strips applied to end folds of the folded pack.

The lateral strips are seal-tightly glued to the fold profiles and the head strips form also a seal-tight closure.

A fold spacing of the folded pack lies, for example, between 3 and 5 mm and a fold height between 16 and 30 mm. In embodiments, from 100 to 150 folds can be present.

In embodiments, the frame is produced from a plastic material, for example a hard plastic material, wherein the partial filter elements (particle filter element and adsorption filter element) for forming the interior room filter module for example rest directly on each other and are connected to each other seal-tightly by means of the frame.

In particular, the frame can be provided as an injection-molded plastic frame. It can either be pre-manufactured and receive the partial filter elements which are glued or welded in the frame. As an alternative, the frame can be embodied as a molded-on frame which is formed in that the partial filter elements are placed into a mold and subsequently molded around with an injection-molded frame, wherein the respective material upon hardening is connected non-detachably to the partial filter elements.

Conceivable is furthermore that the frame is formed by a potting compound of polyurethane (PUR) or another pourable polymer, for example of a foamed polyurethane, i.e., polyurethane foam.

In embodiments, the interior room filter module comprises furthermore an auxiliary frame which surrounds laterally at least partially the particle filter element and the adsorption filter element and fastens them to each other. In this way, the manufacture of the interior room filter module can be simplified by an improved handling of the semifinished parts or components of the filter module. The auxiliary frame can be connected to the frame, for example glued or foamed. As an alternative or in addition, the particle filter element and the adsorption filter element can be glued to the auxiliary frame.

In particular, the auxiliary frame can surround the particle filter element and the adsorption filter element completely circumferentially. In particular, the auxiliary frame can comprise a nonwoven material or can be comprised thereof. The nonwoven material of the auxiliary frame can comprise a greater thickness than the filter medium of the particle filter element. As an alternative or in addition, the nonwoven material of the auxiliary frame can comprise a higher bending stiffness than the filter medium of the particle filter element.

In embodiments of the interior room filter module, an intermediate filter layer is furthermore arranged at the outflow side of the adsorption filter element. The intermediate filter layer is formed as the last filter stage at the outflow side of the filter module according to the invention. Outflow of, for example, particle-shaped adsorber material after adverse mechanical/abrasive force action can thus be prevented. This is important in order to prevent that adsorber material can escape from the honeycomb body to a clean side and thus reach an interior room in operation. Furthermore, due to the intermediate filter layer, it is prevented that adsorber material is Alost@ from the adsorption filter element so that it is ensured that the adsorption capacity of the filter module is maintained over its planned service life.

In embodiments, the adsorption filter element comprises a plurality of shaped bodies which are connected to each other, for example by means of a thermosetting potting compound.

As shaped bodies, honeycomb bodies are conceivable, in particular like those described in EP 2 946 827 A1 which is referenced here with respect to its entire contents (“incorporation by reference”).

The at least one shaped body in the embodiments is manufactured at least partially of a ceramic material, active carbon material, ion exchanger material, molecular sieve material, zeolite material, organometallic support material and/or metal material.

Thus, as materials of the shaped body in particular the materials disclosed in the paragraphs to of EP 2 946 827 A1 are conceivable. The shape and inner geometry of the shaped body is embodied in particular as described for the honeycomb bodies of EP 2 946 827 A1 (compare, for example, paragraphs [0014]-[0031] of EP 2 946 827 A1).

In comparison to known embodiments of adsorption filter elements, for example, folded, stacked or wound layers of filter media provided with adsorbent agents (so-called combination filter media) or bulk fillings, the use of a honeycomb body as an adsorption filter element comprises the advantage of a significantly lower flow resistance. In addition, with a honeycomb body a very high adsorption capacity can be provided so that such a honeycomb body can be used significantly longer until gas breakthrough occurs.

The honeycomb body may be formed as an extruded body which structurally comprises channels and walls arranged therebetween. The channels pass through the honeycomb body and may be open at both ends so that the air to be filtered can flow through between an inflow side and an outflow side. The pressure loss which is caused thereby results primarily from friction effects of the air at the channel walls-a blockage effect as in Aclassic@ filter media does not occur.

Thus, already the use of a honeycomb body is surprising and, to a person of skill in the art, is not comparable to alternative adsorption filter concepts, in particular not to folded, stacked or wound layers of combination filter media.

The wall thickness of the channel walls of the honeycomb body can lie between 200 micrometers and 400 micrometers in embodiments. Such channel dimensions are advantageous in order to obtain a honeycomb body with a high number of channels and thus a large contact surface for the air to be filtered.

The number of channels in the honeycomb body can lie between 40 and 100 channels per square centimeter. This channel density has been found to be advantageous in order to achieve a minimal pressure loss at a high adsorption performance.

The honeycomb body can be produced from active carbon or can comprise active carbon. The active carbon, in the form of a paste or as part of a paste that comprises in addition to active carbon particles at least a suitable binder material, can be extruded easily to a honeycomb body. The proportion of active carbon in the honeycomb body can lie, for example, between 50 and 80 percent by weight. When manufacturing the honeycomb body, the pasty starting material after extrusion is first subjected to one or several drying steps and subsequently sintered at high temperature. In this context, binders contained in the paste are pyrolyzed and there remains a porous structure of active carbon. The aforementioned composition of the paste has been found to be advantageous in order to be able to introduce, on the one hand, a sufficient quantity of active carbon into the honeycomb body and in order to ensure, on the other hand, the mechanical stability of the honeycomb body.

The honeycomb body in embodiments can be provided with an impregnation which improves the separation of harmful gases that are no hydrocarbons. In particular, by means of the impregnation the separation of NH3 and/or H2S can be improved.

In embodiments, the particle filter element, the adsorption filter element, the shaped body and/or the interior room air filter module itself is embodied in a cuboid shape, respectively. Cuboid-shaped components can be combined beneficially to the filter module and enable an efficient installation space utilization.

Furthermore, in particular in case of cuboid exterior dimensions, mirror symmetries may result in relation to certain planes through the filter module which enable a beneficial mass distribution of the filter module. It has been found to be beneficial to adjust a center of gravity of the filter module relative to the attachment or mount at a filter housing in such a way that vibrations or movements of the vehicle cause only reduced mechanical loads.

In embodiments, the seal flange defines a seal plane and the seal flange is arranged such that the seal plane extends through the interior of the shaped body.

For example, the protruding seal flange surrounds circumferentially the circumferentially extending side parts of the frame as a protruding flat collar in order to be held between corresponding seal surfaces of a housing, optionally by use of one or a plurality of seals that follow a flange contour, and to separate a raw air region from a clean air region.

A seal plane can be understood as a spatial plane in which the seal flange or the additional seal is positioned in the mounted state. Such a (fictitious) plane divides the filter module into a first part and a second part. Each of the two parts then encompasses a mass proportion and the sum of the two mass proportions adds up to the total mass of the filter module.

Therefore, in embodiments the seal flange can define a corresponding seal plane which divides the interior room air filter module into a first half and a second half, wherein the seal flange is arranged such that a ratio between a mass of the first half of the interior room air filter module and a mass of the second half of the interior air filter module has a predetermined value. The value is, for example, between 0.5 and 1.5, preferably between 0.6 and 1.4, particularly preferred between 0.8 and 1.2. Even more preferred, the value is between 0.9 and 1.1. In an embodiment with a value of 1.0, the center of mass of the interior room air filter module lies in the seal plane.

One speaks of an axial direction and radial direction of the filter module, wherein “Axial” is understood as extending in flow direction, thus perpendicular to an inflow surface or inflow side of the, for example, cuboid-shaped filter module. “Radial” is understood in particular as a normal direction of a side surface or side wall of the frame or of a lateral surface of the in particular cuboid-shaped filter element.

In addition to the filter module, a filter assembly with a filter housing for receiving at least one filter module as described above or in the following is proposed, wherein the filter housing comprises a first and second seal section following the contour of the seal flange and/or of the seal.

In embodiments, the seal flange and/or the seal is axially compressed between two housing parts when the filter module is arranged as intended in the filter housing.

The filter assembly may be designed for a filtration according to category 4 according to DIN EN 15695-1. Therefore, a use of the filter module as interior room air filter for a driver cabin of agricultural and work machines such as tractors, combines or harvesters, in particular with squirting or spraying devices for plant protectants or fertilizers, is proposed.

The norms and standards mentioned above and in the following are understood as those of the point in time of the filing date of this application.

Further possible implementations of the invention comprise also combinations not explicitly mentioned of features disclosed above or in the following in relation to the embodiments. In this context, a person of skill in the art will add also individual aspects as improvements or supplements to the respective basic form of the invention.

Further embodiments of the invention are subject matter of the dependent claims as well as of the embodiments of the invention described in the following. In the following, the invention will be explained in more detail with the aid of embodiments with reference to the attached Figures.

### BRIEF DESCRIPTION OF DRAWINGS

FIG. 1 shows a partial longitudinal section view of an embodiment of an interior room air filter module.

FIG. 2 shows a cross-sectional view of the embodiment of an interior room air filter module.

FIG. 3 shows a perspective exploded illustration of the interior room air filter module of FIGS. 1 and 2.

FIG. 4 shows a perspective and cutaway illustration of an embodiment of a filter assembly with an interior room air filter module of FIGS. 1-3.

FIG. 5 shows a cross-sectional view of the filter assembly of FIG. 4.

In the Figures, same or functionally the same elements, if nothing to the contrary is indicated, are provided with the same reference characters.

### DETAILED DESCRIPTION

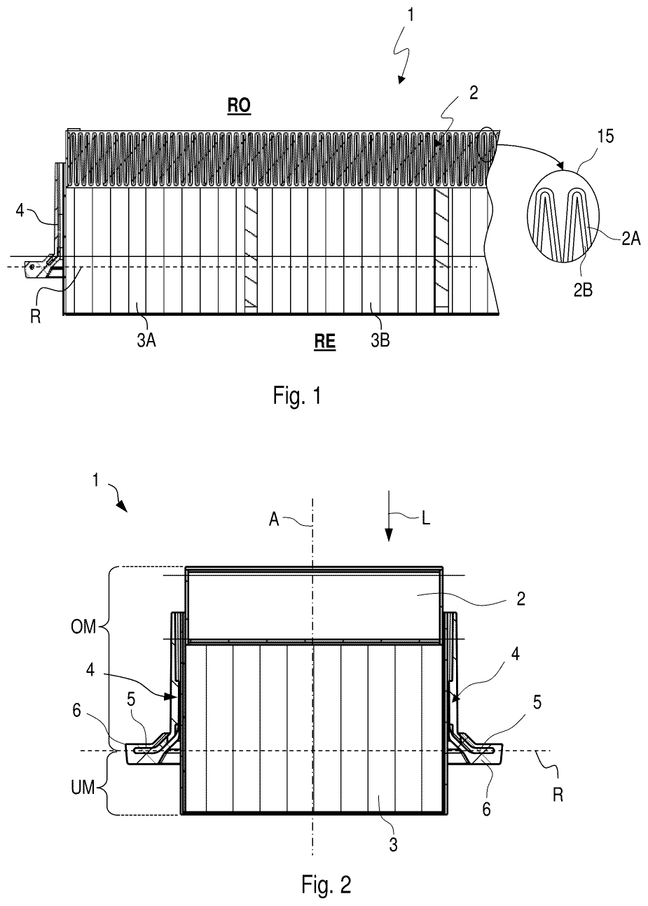

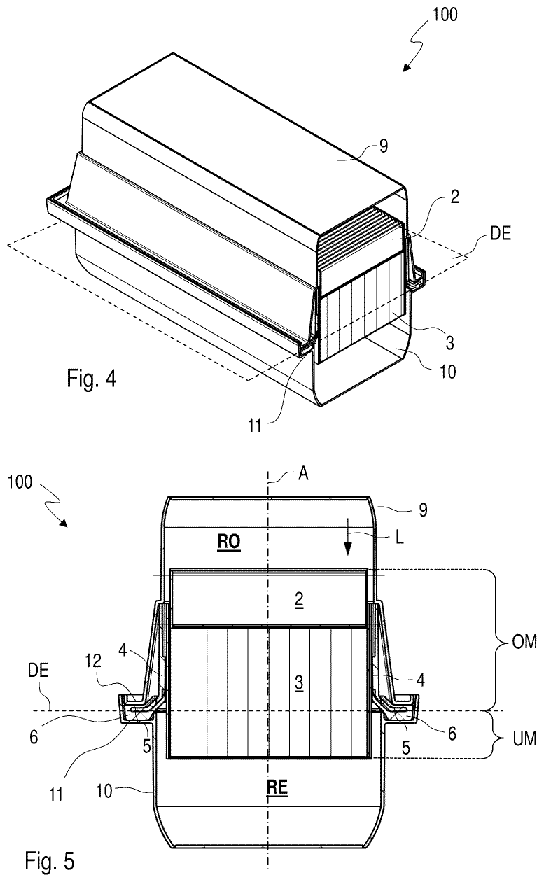

In the following, an embodiment of the filter module as interior room filter module for the supply air of a driver cabin of an agricultural vehicle and its use in a corresponding filter assembly will be described. The interior room air filter module is illustrated in FIGS. 1-3 in different views, and FIGS. 4 and 5 show the interior room air filter module in a filter housing as filter assembly in order to embody an interior room filter of the category 4 of the European norm DIN EN 15695. In this context, it is primarily aerosols and gaseous contaminants in the air, in addition to dust, that should not reach the driver cabin for the protection of the driver.

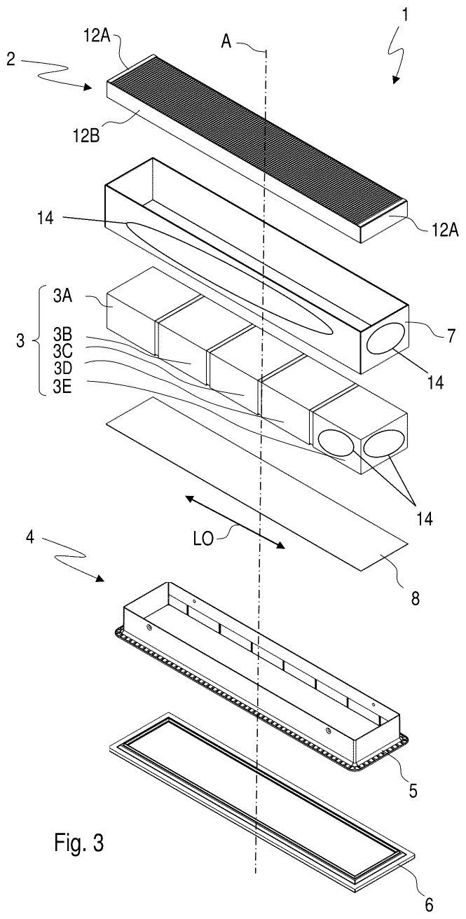

In flow direction L (compare in the orientation of FIG. 3 from top to bottom), the interior room filter module 1 comprises a particle filter element 2 which corresponds to a filter class H13 or H14 according to DIN EN 1822. Thus, a HEPA filter (suspended particle filter or high efficiency particulate air) is provided which allows only possible gaseous air contaminants to pass. The particle filter element 2 is comprised of a folded pack which is formed of a two-layer flat filter medium folded in a zigzag shape and of a circumferentially extending rim which is formed of two head strips 12A and two lateral strips 12B. A flat cuboid-shaped geometry of the particle filter element 2 results.

The folded pack or the folded bellows is illustrated in FIG. 1 with partial enlargement. A first layer 2A (pre-filter layer) and a second layer 2B (fine filter layer) of the filter medium 15 are placed initially loosely on each other during manufacture and are then folded together in a zigzag shape. In order to maintain the fold profiles, the lateral strips 12B are glued on. At the end folds, a head strip 12A is applied, respectively, so that a partial filter element 2 results which can be handled. The pre-filter layer 2A is formed of a synthetic plastic material nonwoven such as PET, PP or PC. The fine filter layer 2B is formed of an ePTFE material. An air permeability of the media composite of the layers 2A, 2B of approximately 87 l/m2s results. FIG. 1 shows in this context a partial longitudinal section along the length direction LO, visible in FIG. 3, of the rod-shaped cuboid of the interior room filter module 1 and a cross section perpendicular to the length direction LO in FIG. 2.

An adsorption filter element 3 formed of honeycomb bodies 3A-3E follows downstream of the particle filter element 2. The cuboid-shaped honeycomb bodies 3A-3E are fastened to each other seal-tightly by a potting compound. The pre-purified air flows in operation of the interior room filter module 1 through the at least hydrocarbon-adsorbing material of the respective honeycomb body 3A-3E. For example, honeycomb bodies 3A-3E are used as they are described in EP 2 946 827 A1.

The particle filter element 2 and the adsorption filter element 3 are held at each other by means of a four-sided auxiliary frame 7. The bottom side of the particle filter element 2 and the top side of the adsorption filter element 3 are contacting each other in this context and the auxiliary frame 7, manufactured of a nonwoven or lateral strip material and attached laterally to the side strips and head strips 12B, 12A as well as to the outer side surfaces (compare markings 14 in FIG. 3) of the honeycomb bodies 3A-3E, holds the two partial filter elements 2, 3 together.

To the bottom side of the adsorption filter element 3, a flat intermediate filter layer 8 of a nonwoven material is applied in order to prevent, for example, outflow of adsorption particles from the adsorption filter element 3. The intermediate filter layer comprises for example a nonwoven material, wherein the nonwoven material comprises for example a higher air permeability than the filter medium of the particle filter element. The intermediate filter layer 8 is for example a planar layer and for example is not folded.

The auxiliary frame 7 and the intermediate filter layer 8 increase furthermore the stability and thus handling of the interior room filter module 1. Furthermore, the filter module 1 is thus more resistant in relation to accelerations such as vibrations, rattling or shocks.

The cuboid-shaped unit of the partial filter elements 2, 3 connected to each other by the auxiliary frame 7 and closed off by the intermediate filter layer 8 in downward direction is enclosed laterally by a plastic frame 4 which comprises a radially protruding seal stay or seal flange 5. In the Figures, an axial direction A is indicated in dash-dotted line and a radial direction R is indicated in dashed line. In a state inserted into a housing, the seal stay 5 is axially clamped between two corresponding housing parts 9, 10 by a seal 6 (compare FIG. 5).

In the filter assembly 100 illustrated in FIGS. 4 and 5, the filter housing is formed of a housing top part 9 and a housing bottom part 10. The housing bottom part 10 has a U-profile shaped laterally outwardly protruding receiving stay (seal section) 11 for the seal 6 of the interior room filter module 1. The housing top part 9 has a profile stay (seal section) 12 corresponding therewith which pushes the seal 6 arranged around the seal flange 5 axially against the receiving stay 11 and thus provides an air-tight sealing action.

Within the filter assembly 100, a raw air region RO and a clean air region RE are thus present. The air which is to be filtered and potentially loaded with dust and gases enters the raw air region RO through an inlet, not illustrated, is driven through the two partial filter elements 2, 3 due to a pressure differential, and collects in the clean air region RE as purified air for the vehicle cabin interior. From the clean air region RE, the clean air is then supplied through an outlet, not illustrated, to the vehicle cabin.

The seal flange 5 and the seal 6 as well as the housing sections 11, 12 may have a rectangular shape. One can speak of a seal plane DE that, as illustrated in FIG. 4, passes through the interior room of the housing 9, 10 and the inner volume of the cuboid-shaped adsorption filter element 3. The seal plane DE corresponds in FIGS. 1 and 2 to the illustrated radial direction R.

In order to obtain a mass ratio which is balanced in relation to the mount of the interior room filter module 1 by the seal stay 5/the seal 6 at the housing parts 9, 10, the seal plane DE in this embodiment extends through the center of mass of the interior room filter module 1. More precisely, the seal plane DE defined by the positioning of the seal flange 5 divides the total mass of the interior room filter module 1 into a top half OM and a bottom half UM. The interior room filter module 1 is fastened in the housing 9, 10 stably in relation to accelerations for example when the mass of the first half OM of the interior room air filter module 1 and the mass of the second half UM of the interior room filter module 1 are equal.

In case of unequally distributed mass proportions of the interior room air filter module 1 in relation to the seal plane DE, there is a higher risk for acceleration-caused tensions than in the proposed Aequilibrium state@. One can say that the top part or the top half OM of the interior room air filter module 1 is approximately equally as heavy as the bottom part or the bottom half UM of the interior room air filter module 1 when the plane which is defined by the seal flange is considered as a dividing plane (seal plane DE). In this context, certain tolerances in relation to the mass ratios are acceptable.

In the present embodiment, the seal flange 5 surrounds the adsorption filter element 3, respectively, is positioned opposite a respective side 14 of the shaped body 3A-3B or of the auxiliary frame 7 at the level of the honeycomb bodies 3A-3B of the adsorption filter element 3. As a function of the axial mass distribution of the composite of partial filter elements 2, 3, the seal flange 5 can be positioned also at a deviating axial height of the filter element composite.

As a whole, a reliable filter module with efficiently employed filter media is thus provided that, due to its lateral outer mount in a housing, is particularly robust in relation to vibrations.

### REFERENCE CHARACTERS

1 interior room air filter module
2 particle filter element
2A pre-filter layer
2B HEPA layer
3 adsorption filter element
3A-3E shaped bodies
4 frame
5 seal flange
6 seal
7 auxiliary frame
8 intermediate filter layer
9 housing part
10 housing part
11 seal receiving section, seal section
12 profile stay, seal section
12A head strip
12B lateral strip
14 markings; circumferentially extending wall of the adsorption filter element
15 filter medium
100 filter assembly
A axial direction
DE seal plane
R radial direction
L flow direction
LO length direction
OM top half
UM bottom half
RE clean side
RO raw side

What is claimed is:

1. An interior room air filter module comprising:
a particle filter element;
an adsorption filter element;
a first frame circumferentially surrounding the particle filter element and the adsorption filter element, wherein the first frame comprises a radially protruding seal flange;
wherein the particle filter element comprises a folded pack, wherein the folded pack comprises layers of filter medium folded in a zigzag shape, and wherein the layers of filter medium include at least one layer comprising an aerosol-separating filter medium;
wherein the layers of filter medium include a first layer of filter medium at an inflow side of the particle filter element and further include a second layer of filter medium at an outflow side of the particle filter element;
wherein the first layer of filter medium and the second layer of filter medium, for forming the folded pack, are folded while resting on each other;
wherein the adsorption filter element comprises one or more shaped bodies configured as a honeycomb body, respectively, and configured to adsorb at least hydrocarbons;
wherein the radially protruding seal flange is arranged so as to laterally surround circumferentially the adsorption filter element at a circumferentially extending exterior wall of the adsorption filter element.

2. The interior room air filter module according to claim 1, wherein the radially protruding seal flange defines a seal plane and is arranged such that the seal plane extends through an interior of the one or more shaped bodies of the adsorption filter element.

3. The interior room air filter module according to claim 1, wherein the radially protruding seal flange defines a seal plane dividing the interior room air filter module into a first half and a second half, wherein the radially protruding seal flange is arranged such that a ratio of a mass of the first half to a mass of the second half amounts to a value between 0.6 and 1.4.

4. The interior room air filter module according to claim 1, further comprising a second frame, wherein the second frame is an auxiliary frame surrounding laterally at least partially the particle filter element and the adsorption filter element, wherein the auxiliary frame connects the particle filter element and the adsorption filter element to each other, wherein the auxiliary frame is connected to the first frame.

5. The interior room air filter module according to claim 4, wherein the auxiliary frame is glued to the first frame.

6. The interior room air filter module according to claim 1, further comprising an intermediate filter layer arranged at an outflow side of the adsorption filter element.

7. The interior room air filter module according to claim 1, wherein the particle filter element comprises a third frame surrounding the folded pack, wherein the third frame comprises lateral strips applied to fold profiles of the folded pack and head strips applied to end folds of the folded pack.

8. The interior room air filter module according to claim 1, wherein the aerosol-separating filter medium is an aerosol-separating particle filter medium of the filtration class H13 or H14 according to DIN EN 1822-1.

9. The interior room air filter module according to claim 1, wherein the shaped bodies of the adsorption filter element are connected to each other.

10. The interior room air filter module according to claim 9, wherein the shaped bodies of the adsorption filter element are connected to each other by a thermosetting potting compound.

11. The interior room air filter module according to claim 1, wherein the one or more shaped bodies of the adsorption filter element are manufactured at least partially of one or more of the materials selected from the group consisting of a ceramic material, an active carbon material, an ion exchanger material, a molecular sieve material, a zeolite material, an organometallic support material, and a metal material.

12. The interior room air filter module according to claim 1, wherein one or more of the parts selected from the group consisting of the particle filter element, the adsorption filter element, the one or more shaped bodies, and the interior room air filter module are embodied in a cuboid shape.

13. The interior room air filter module according to claim 1, further comprising a seal attached to the seal flange.

14. The interior room air filter module according to claim 1, wherein the particle filter element and the adsorption filter element are arranged in the interior room air filter module so as to be flowed through in series.

15. The interior room air filter module according to claim 14, wherein the particle filter element is arranged upstream of the adsorption filter element.

16. A filter assembly comprising:
a filter housing configured to receive at least one of the interior room air filter module according to claim 1, wherein the filter housing comprises a first seal section and a second seal section, wherein the first seal section and the second seal section are configured to follow a contour of the seal flange and/or of a seal attached to the seal flange.

17. The filter assembly according to claim 16, wherein the filter housing comprises two housing parts, wherein the seal flange and/or the seal is axially compressed between the two housing parts when the interior room air filter module is arranged as intended in the filter housing.

18. The filter assembly according to claim 16, wherein the filter assembly is designed for a filtration according to category 4 according to DIN EN 15695-1.
